(19) United States
(12) Patent Application Publication
(10) Pub. No.: US 2026/0152630 A1
(43) Pub. Date: Jun. 4, 2026

(54) COMPOSITION FOR POLYMER BLEND, POLYMER BLEND, AND MOLDED ARTICLE COMPRISING POLYMER BLEND

(71) Applicants: HYUNDAI MOTOR COMPANY, SEOUL (KR); KIA CORPORATION, SEOUL (KR); INHA UNIVERSITY RESEARCH AND BUSINESS FOUNDATION, INCHEON (KR)

(72) Inventors: YongBeom Lee, Hwaseong-si (KR); HEEJOON Lee, Hwaseong-si (KR); Jisoo Han, Osan-si (KR); Hee Joong Kim, Seoul (KR); Doyoung Choi, Incheon (KR)

(73) Assignees: HYUNDAI MOTOR COMPANY, SEOUL (KR); KIA CORPORATION, SEOUL (KR); INHA UNIVERSITY RESEARCH AND BUSINESS FOUNDATION, INCHEON (KR)

(21) Appl. No.: 19/459,624

(22) Filed: Jan. 26, 2026

(30) Foreign Application Priority Data
Sep. 16, 2024 (KR) 10-2025-0132416

(51) Int. Cl. C08L 23/12; C08G 18/24

(52) U.S. Cl. CPC C08L 23/12; C08G 18/244; C08L 2205/08; C08L 2205/22

(57) ABSTRACT

A composition for a polymer blend, a polymer blend, and a molded article comprising the polymer blend. A composition for a polymer blend includes a polymer component including a first polymer and a second polymer that is different from the first polymer, a polypropylene-based compatibilizer having hydroxyl groups (—OH) at both terminal ends, and a catalyst component including a tin-based catalyst, a zirconium-based catalyst, or combinations of such catalysts.

### CROSS-REFERENCE TO RELATED APPLICATION(S)

The present application claims the benefit of priority to Korean Patent Application No. 10-2025-0132416, filed on Sep. 16, 2025, in the Korean Intellectual Property Office, the entire disclosure of which is incorporated herein by reference.

### TECHNICAL FIELD

The present disclosure relates to a composition for a polymer blend, a polymer blend, and a molded article comprising the polymer blend.

### BACKGROUND

With increasing interest in plastic pollution and environmental issues, implementing a circular economy through recycling has emerged as an important challenge. In major markets, the adoption of sustainable plastic production and recycling technologies is required, and reducing the use of virgin plastics and utilizing recycled raw materials have been presented as representative strategies. Polypropylene is a material widely used in various fields such as packaging materials, home appliances, and automotive parts. However, when polypropylene is mixed with other materials, separation and recycling become difficult, resulting in a waste disposal problem.

With the strengthening of international regulations, the use of recycled raw materials is required even in new products, but most polymers are thermodynamically immiscible, and therefore phase separation occurs upon blending. As a result, interfacial adhesion may decrease and voids may form, and fracture may readily occur under mechanical load. Furthermore, when various waste plastics are mixed without sorting for mechanical recycling, the mechanical properties may deteriorate markedly.

Compatibilizers are used to address this issue, and compatibilizers are broadly classified into non-reactive and reactive types. Block copolymers are typical non-reactive compatibilizers that may improve compatibility through physical interactions between polymers. However, their commercial use is limited by complex synthesis procedures and the need for high molecular weight and/or multiple block architectures. Reactive compatibilizers induce interfacial chemical reactions to form interpolymer covalent bonds, and therefore may achieve strong interfacial adhesion. However, in actual processes, these reactions may proceed excessively or non-uniformly during processing, making it difficult to achieve stable, consistent performance.

Accordingly, there is a need to develop new compatibilizers capable of overcoming property deterioration caused by phase separation and reliably achieving strong interfacial adhesion.

The matters described in this Background section are only for enhancement of understanding of the background of the disclosure, and should not be taken as acknowledgement that they correspond to prior art already known to those skilled in the art.

### SUMMARY

The following summary presents a generalized summary of certain aspects, embodiments, features and advantages. The summary is not an extensive overview and is not intended to identify key or critical elements.

The present disclosure is directed to providing a composition for a polymer blend that may achieve improved interfacial adhesion.

The present disclosure is further directed to providing a polymer blend having improved mechanical properties and a molded article including the polymer blend.

An aspect of the present disclosure may provide a composition for a polymer blend, including a polymer component including a first polymer and a second polymer different from the first polymer, a polypropylene-based compatibilizer having hydroxyl groups (—OH) at both terminal ends, and a catalyst component including one or more of a tin-based catalyst, a zirconium-based catalyst, or combinations thereof.

In one embodiment, the polypropylene-based compatibilizer may be included in an amount of 0.01 to 10 parts by weight based on 100 parts by weight of the polymer component.

In one embodiment, the polypropylene-based compatibilizer may have a number-average molecular weight (Mn) of 1,000 g/mol to 30,000 g/mol.

In one embodiment, the catalyst component may be included in an amount of 0.01 to 10 parts by weight based on 100 parts by weight of the polymer component.

In one embodiment, the catalyst component may include one or more of dibutyltin dilaurate (DBTDL), tin(II) 2-ethylhexanoate (Sn(Oct)₂), zirconium acetylacetonate, or zirconium tetrakis(2,2,6,6-tetramethyl-3,5-heptanedionate).

In one embodiment, the second polymer may be crosslinked.

In one embodiment, the first polymer may not include polar functional groups, and the second polymer may include polar functional groups.

In one embodiment, the first polymer may include a polyolefin-based polymer, and the second polymer may include a polyurethane-based polymer.

In one embodiment, the first polymer may include a polypropylene-based polymer, and the second polymer may include a crosslinked polyurethane-based polymer.

In one embodiment, the polymer component may include 30 wt % to 95 wt % of the first polymer and 5 wt % to 70 wt % of the second polymer.

Another aspect of the present disclosure may provide a polymer blend including a polymer component including a first polymer and a second polymer different from the first polymer, a polypropylene-based compatibilizer residue covalently bonded to the second polymer, and a catalyst component including one or more of a tin-based catalyst, a zirconium-based catalyst, or combinations thereof.

In one embodiment, the compatibilizer residue may be derived from a polypropylene-based compatibilizer having hydroxyl groups (—OH) at both terminal ends.

In one embodiment, the polymer component may include a continuous phase including the first polymer and a dispersed phase including the second polymer.

In one embodiment, the compatibilizer residue may be bonded to the second polymer via urethane bonds.

In one embodiment, the catalyst component may include one or more of dibutyltin dilaurate (DBTDL), tin(II) 2-ethylhexanoate (Sn(Oct)₂), zirconium acetylacetonate, or zirconium tetrakis(2,2,6,6-tetramethyl-3,5-heptanedionate).

Furthermore, another aspect of the present disclosure may provide a molded article including the polymer blend described above.

In one embodiment, the molded article may have a yield stress of 15 MPa or greater as measured in accordance with ASTM D638.

In one embodiment, the molded article may have a tensile modulus of 750 MPa or greater as measured in accordance with ASTM D638.

In one embodiment, the molded article may have an impact strength of 50 kJ/m² or greater as measured in accordance with ASTM D256.

In one embodiment, the molded article may have a crystallinity of 48% or greater as measured by differential scanning calorimetry.

The composition for a polymer blend according to embodiments of the present disclosure may address the issue of property deterioration caused by phase separation by improving interfacial adhesion between two or more polymers.

In addition, the polymer blend according to embodiments of the present disclosure and the molded article including the polymer blend may have improved mechanical properties.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a schematic view of a composition for a polymer blend according to one embodiment, and FIG. 2 is a schematic view of a polymer blend manufactured from the composition.

FIG. 3 is a scanning electron microscopy (SEM) cross-sectional image of Comparative Example 2, FIG. 4 is an SEM cross-sectional image of Comparative Example 3, FIG. 5 is an SEM cross-sectional image of Example 1, FIG. 6 is an SEM cross-sectional image of Example 2, and FIG. 7 is an SEM cross-sectional image of Example 3.

FIG. 8 is an SEM cross-sectional image taken after tensile testing of the polymer blend film of Example 2, and FIG. 9 is an SEM cross-sectional image taken after tensile testing of the polymer blend film of Example 3.

FIG. 10 is a loss tangent graph versus frequency for Examples and Comparative Examples.

FIG. 11 is a complex viscosity graph versus frequency for Examples and Comparative Examples.

FIG. 12 is a loss tangent graph versus temperature for Examples and Comparative Examples.

FIG. 13 is a graph showing thermogravimetric analysis curves versus temperature for Examples and Comparative Examples.

FIG. 14 is an oxygen elemental mapping image obtained by scanning electron microscopy-energy dispersive X-ray spectroscopy (SEM-EDS) of the polymer film manufactured in Comparative Example 5.

FIG. 15 is an oxygen elemental mapping image obtained by SEM-EDS of the polymer film manufactured in Example 4.

### DETAILED DESCRIPTION

Embodiments described in the present specification can be modified into various other forms, and the technology according to exemplary embodiments is not limited to the embodiments described below. The exemplary embodiments are provided to make the description of the present disclosure thorough and to fully convey the scope of the present disclosure to those skilled in the art.

The above and other objects, features and advantages of the present disclosure will be more clearly understood from the following aspects and embodiments taken in conjunction with the accompanying drawings. However, neither the present disclosure nor the claims are limited to the embodiments disclosed herein, and may be modified into different forms in accordance with the guidance provided herein. The example aspects and embodiments are provided herein in an effort to thoroughly explain the various features of the disclosure and to convey the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise” or “comprising”, “include” or “including”, “have” or “having”, etc., when used in this specification, specify the presence of stated features, integers, steps, operations, elements, components, or combinations thereof, but do not preclude the presence or addition of one or more other features, integers, steps, operations, elements, components, or combinations thereof. In some aspects and embodiments, these terms should be understood to encompass the terms “consisting of” and “consisting essentially of” which refer to features, integers, numbers, steps, operations, elements, components, parts, or combinations thereof that only include the recited components, or the recited components allowing for minor amounts of other components or elements that do not have a material effect on the function of the recited feature, component, embodiment, or aspect of the disclosure. Thus, some aspects and embodiments may refer to these various transitionary terms, all of which form part of the disclosure.

Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

Furthermore, unless specifically stated otherwise, the term “about” as used or implied herein may be understood within a range of error that is typical in the art (e.g., within 2 standard deviations of the mean). “About” may be understood as within 10%, 9%, 8%, 7%, 6%, 5%, 4%, 3%, 2%, 1%, 0.5%, 0.1%, 0.05%, or 0.01% of the stated value.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

A composition for a polymer blend according to the present disclosure may include a polymer component comprising a first polymer and a second polymer different from the first polymer, a polypropylene-based compatibilizer having hydroxyl groups (—OH) at both terminal ends of the polypropylene group, and a catalyst component comprising one or more of a tin-based catalyst, a zirconium-based catalyst, or combinations thereof.

Without being limited by any particular mechanism, it may be that including a polypropylene-based compatibilizer and a catalyst, provides the composition for a polymer blend according to the present disclosure that may address the issues of phase separation and property deterioration that may occur when the first polymer and the second polymer are simply mixed. In some embodiments, the polypropylene-based compatibilizer is present in the first polymer phase while its hydroxyl groups react with the second polymer in the presence of the catalyst, and thereby may improve interfacial adhesion. Accordingly, a polymer blend in which the different polymers are uniformly dispersed may be implemented, and mechanical properties such as yield stress, elongation, and tensile modulus may be improved. Additionally, a polymer blend prepared using the composition may secure high crystallinity and may improve both thermal stability and structural stability.

Moreover, these effects may also be realized in systems that include recycled raw materials, which is advantageous for the use of recycled plastics.

In embodiments, the content of the polypropylene-based compatibilizer may be 0.01 parts by weight or more, 0.05 parts by weight or more, 0.1 parts by weight or more, 0.5 parts by weight or more, 10 parts by weight or less, 8 parts by weight or less, 7 parts by weight or less, 5 parts by weight or less, or an intermediate value between the foregoing values, based on 100 parts by weight of the polymer component. For example, in some embodiments, the polypropylene-based compatibilizer may be included in amounts of 0.01 to 10 parts by weight, 0.05 to 8 parts by weight, 0.1 to 7 parts by weight, or 0.5 to 5 parts by weight, based on 100 parts by weight of the polymer component. Embodiments that maintain the content within this range may provide a composition for a polymer blend capable of achieving robust interfacial adhesion.

In embodiments, the polypropylene-based compatibilizer may have a number-average molecular weight (Mn) of 1,000 g/mol or more, 2,000 g/mol or more, 3,000 g/mol or more, 30,000 g/mol or less, 20,000 g/mol or less, 10,000 g/mol or less, 6,000 g/mol or less, 4,500 g/mol or less, or values between the foregoing values. For example, in some embodiments, the polypropylene-based compatibilizer may have a number-average molecular weight (Mn) of 1,000 g/mol to 30,000 g/mol, 1,000 g/mol to 20,000 g/mol, 2,000 g/mol to 10,000 g/mol, 3,000 g/mol to 6,000 g/mol, or 3,000 g/mol to 4,500 g/mol. In embodiments, the number-average molecular weight may be measured by high-temperature gel permeation chromatography (HT-GPC). Any HT-GPC method used in the art may be employed without particular limitation.

In embodiments, the polypropylene-based compatibilizer may have a polydispersity index (Mw/Mn: PDI) of 1 to 3, 1.5 to 3, 1.5 to 2.5, 2 to 2.5, or 2 to 2.3. A compatibilizer having such a molecular-weight range and polydispersity index may more effectively improve the compatibility between the first polymer and the second polymer. Accordingly, issues of phase separation and property deterioration due to mixing of different polymers may be more effectively addressed.

In embodiments, the polypropylene-based compatibilizer may include hydroxyl groups (—OH) at both terminal ends of the polypropylene-based main chain. For example, in some embodiments, the polypropylene-based compatibilizer may be a polymer compound represented by Chemical Formula 1 below. Here, n may be a number within an appropriate range according to the number-average molecular weight (e.g., as described herein).

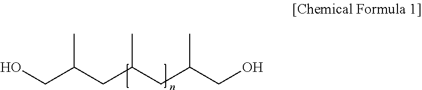

In embodiments, the content of the catalyst component may be 0.01 parts by weight or more, 0.1 parts by weight or more, 0.5 parts by weight or more, 1 part by weight or more, 10 parts by weight or less, 8 parts by weight or less, 7 parts by weight or less, 5 parts by weight or less, or values between the foregoing values, based on 100 parts by weight of the polymer component. For example, in some embodiments, the catalyst component may be included in amounts of 0.01 to 10 parts by weight, 0.1 to 8 parts by weight, 0.5 to 7 parts by weight, or 1 to 5 parts by weight, based on 100 parts by weight of the polymer component. Embodiments that maintain the amount of the catalyst component within this range may promote reactions between the polypropylene-based compatibilizer and the second polymer, thereby providing a composition for a polymer blend capable of achieving robust interfacial adhesion.

In embodiments, the catalyst component may include one or more of dibutyltin dilaurate (DBTDL), tin(II) 2-ethylhexanoate (Sn(Oct)₂), zirconium acetylacetonate, or zirconium tetrakis(2,2,6,6-tetramethyl-3,5-heptanedionate). In terms of promoting reactions between the polypropylene-based compatibilizer and the second polymer, in some embodiments, the catalyst component may include dibutyltin dilaurate (DBTDL).

In embodiments, the second polymer may be crosslinked. The polypropylene-based compatibilizer may react with the crosslinked second polymer to improve interfacial adhesion.

Crosslinked polymers may react less effectively with existing compatibilizers, which may limit improvement of interfacial adhesion. This is because, due to the crosslinked structure, reactive functional groups may be insufficient or may be isolated within the polymer, which may hinder the smooth formation of chemical bonds with existing compatibilizers.

In contrast, according to embodiments of the present disclosure, a polypropylene-based compatibilizer having hydroxyl groups (—OH) at both terminal ends may effectively form covalent bonds with the crosslinked second polymer through in-situ reactions in the presence of a catalyst component. As a result, interfacial adhesion may be significantly improved, and such effects may also be realized in blends of various recycled materials that include crosslinked polymers, which are generally known to be difficult to reprocess.

In embodiments, the first polymer may be a nonpolar polymer that does not include polar functional groups, and the second polymer may be a polar polymer including polar functional groups. The first polymer may include, for example, a polyolefin-based polymer, and may include homopolyethylene, homopolypropylene, ethylene-propylene copolymers, or combinations thereof. In embodiments, the second polymer may include, for example, one or more functional groups selected from urethane groups, ester groups, and amide groups, and may include one or more polymers selected from polyurethane-based polymers, polyamide-based polymers, and polyester-based polymers.

Because nonpolar polymers such as polyolefin-based polymers may not comprise polar functional groups, when blended with polar polymers as described above, interfacial adhesion may be low and phase separation may occur. Accordingly, during mechanical recycling, the properties of the resulting polymer blends may deteriorate.

According to embodiments, by using polypropylene-based compatibilizers together with a catalyst component, these issues may be effectively addressed. In some embodiments, the polypropylene-based compatibilizer may be uniformly distributed in the nonpolar polymer phase, and may cause in-situ reactions with polar polymers through terminal hydroxyl groups in the presence of the catalyst component. As a result, covalent bonds may be formed at interfaces between different polar and nonpolar polymers, thereby improving interfacial adhesion and suppressing phase separation in blends.

In embodiments, the first polymer may include a polypropylene-based polymer, and the second polymer may include a crosslinked polyurethane-based polymer. In such embodiments, the polypropylene-based polymer may include one or more selected from homopolypropylene, ethylene-propylene copolymers, or combinations thereof. The polypropylene-based compatibilizer may react with the crosslinked polyurethane-based polymer in the presence of the catalyst component to improve interfacial adhesion. Accordingly, polymer blends in which the polypropylene-based polymer and the crosslinked polyurethane-based polymer are uniformly dispersed may be implemented, and mechanical properties such as yield stress, elongation, and tensile modulus may be improved. Additionally, a polymer blend prepared using the composition for a polymer blend may secure high crystallinity, and may improve both thermal stability and structural stability.

In embodiments, the polymer component may include 30 wt % to 95 wt % of the first polymer and 5 wt % to 70 wt % of the second polymer. For example, in some embodiments, the content of the first polymer in the polymer component may be 35 wt % or more, 40 wt % or more, 45 wt % or more, 50 wt % or more, 55 wt % or more, 60 wt % or more, 65 wt % or more, 70 wt % or more, 75 wt % or more, 80 wt % or more, 85 wt % or more, or 90 wt % or more. The upper limit of the content may be, for example, 95 wt % or less, 90 wt % or less, 85 wt % or less, 80 wt % or less, 75 wt % or less, 70 wt % or less, 65 wt % or less, 60 wt % or less, or 55 wt % or less. In embodiments, the second polymer may be included in an amount corresponding to the remaining content, excluding the content of the first polymer, based on a total of 100 wt % of the polymer component. For example, the polymer component may include 70 wt % to 90 wt % of the first polymer and 10 wt % to 30 wt % of the second polymer. The content may, however, be varied insofar as the properties of the present disclosure can be achieved.

In embodiments, the first polymer may have a number-average molecular weight (Mn) of 30,000 g/mol to 500,000 g/mol or 40,000 g/mol to 250,000 g/mol, but is not particularly limited thereto. The number-average molecular weight of the first polymer may be measured by high-temperature gel permeation chromatography (HT-GPC). Any HT-GPC method used in the art may be employed without particular limitation.

In embodiments, the second polymer may have a number-average molecular weight (Mn) of 2,000 g/mol to 200,000 g/mol, but is not particularly limited thereto. The number-average molecular weight of the second polymer may be measured by gel permeation chromatography (GPC) of the tetrahydrofuran (THF)-soluble fraction. For example, the soluble fraction may be obtained by Soxhlet extraction using THE at 60° C. for 24 hours.

In addition, the present disclosure provides a polymer blend prepared using the composition for a polymer blend described above. In embodiments, the polymer blend may include a polymer component including a first polymer and a second polymer different from the first polymer, a polypropylene-based compatibilizer residue covalently bonded to the second polymer, and a catalyst component including one or more of a tin-based catalyst, a zirconium-based catalyst, or combinations thereof.

In embodiments, the compatibilizer residue may be derived from a polypropylene-based compatibilizer having hydroxyl groups (—OH) at both terminal ends.

The first polymer, the second polymer, the polypropylene-based compatibilizer having hydroxyl groups (—OH) at both terminal ends, and the catalyst component are as described above, and are not repeated for purposes of these embodiments.

According to one embodiment, in the presence of the catalyst component, the polypropylene-based compatibilizer having hydroxyl groups (—OH) at both terminal ends may react with a portion of the second polymer to provide a polypropylene-based compatibilizer residue that is covalently bonded to the second polymer. Accordingly, phase separation between the first polymer and the second polymer may be suppressed, and high miscibility may be secured. Such improvement in interfacial adhesion may significantly enhance the mechanical properties and structural stability of the polymer blend.

Furthermore, even when the second polymer is crosslinked, the polymer blend may have superior mechanical properties and crystallinity by including a polypropylene-based compatibilizer residue that is covalently bonded to the second polymer.

In embodiments, the polymer component may include a continuous phase including the first polymer and a dispersed phase including the second polymer. The continuous phase may refer to the portion of the polymer blend other than the dispersed phase. The dispersed phase may be formed by physical separation due to differences in properties between the second polymer and the first polymer, and may be present as a plurality within the polymer blend. For example, the dispersed phase may be visually identified in cross-sectional images observed by scanning electron microscopy (SEM).

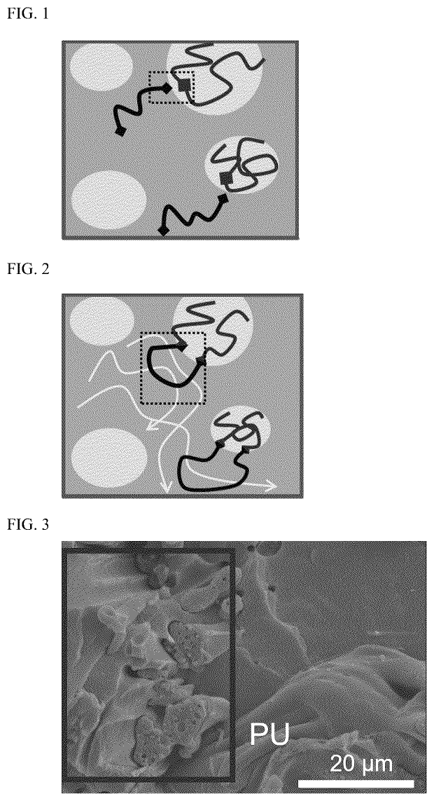

FIG. 1 is a schematic view of a composition for a polymer blend according to one embodiment, and FIG. 2 is a schematic view of a polymer blend manufactured from the composition. The catalyst component is not shown in FIGS. 1 and 2. Hereinafter, the process of manufacturing a polymer blend according to one embodiment will be described in detail with reference to the accompanying drawings. The attached drawings are provided merely as examples to sufficiently convey the technical concepts of the present disclosure to skilled persons and are not intended to limit the present disclosure, which may be embodied in various other forms.

Referring to FIGS. 1 and 2, the first polymer may form a continuous phase and the second polymer may form a dispersed phase. The polypropylene-based compatibilizer present in the continuous phase may react with the second polymer in the dispersed phase at the interface between the continuous phase and the dispersed phase to form covalent bonds.

The compatibilizer residue may form urethane bonds with the second polymer. Here, the second polymer may be a polyurethane-based polymer including urethane bonds.

The terminal hydroxyl groups of the polypropylene-based compatibilizer may undergo exchange reactions with urethane bonds of the second polymer in the presence of the catalyst component. In some embodiments, isocyanate (—NCO) groups may be reversibly cleaved from urethane bonds of the second polymer by the catalyst component, and, at this time, the hydroxyl groups may attack the isocyanate groups to form new urethane bonds.

In another embodiment, in the presence of the catalyst component, the hydroxyl groups may directly attack the carbonyl carbon of urethane bonds of the second polymer, thereby causing the hydroxyl groups of existing urethane bonds to depart, and new urethane bonds may be formed in this process.

Through such exchange reactions, the compatibilizer residue forms urethane bonds with the second polymer, thereby improving interfacial adhesion between the first polymer and the second polymer.

Furthermore, the present disclosure provides a method for manufacturing the polymer blend.

In embodiments, the method for manufacturing the polymer blend may include introducing the composition for a polymer blend described above into an extruder.

In embodiments, the composition for a polymer blend may include a polymer component, a polypropylene-based compatibilizer, and a catalyst component including one or more of a tin-based catalyst, a zirconium-based catalyst, or combinations thereof, and each of these components is as described above, and detailed description thereof is omitted.

In embodiments, the timing at which each component is introduced, and the feed inlet through which introduction is made, may be appropriately controlled. For example, each component introduced into the extruder may be introduced simultaneously or at different times, and may be introduced through the same or different feed inlets.

For example, in some embodiments, the method for manufacturing the polymer blend may include introducing into an extruder a mixture comprising a polymer component including a first polymer and a second polymer different from the first polymer, and a polypropylene-based compatibilizer having hydroxyl groups (—OH) at both terminal ends, and introducing into the extruder a catalyst component including one or more of a tin-based catalyst, a zirconium-based catalyst, or combinations thereof.

In embodiments, the temperature of the extruder may be set in the range of 150° C. to 250° C. or 180° C. to 220° C. Kneading may be performed at a screw rotational speed of 50 to 500 rpm or 80 to 300 rpm, but is not particularly limited thereto.

Furthermore, the present disclosure provides a molded article including the polymer blend described above. In embodiments, the molded article may be, for example, an injection-molded product or a film. Such molded articles may be processed into various shapes according to the application and may be applied to various industrial fields such as automotive parts, packaging materials, and electrical/electronic components.

By including the polymer blend, the molded article may have improved mechanical properties such as yield stress, elongation, tensile modulus, and impact strength, and may secure high crystallinity, thereby improving both thermal stability and structural stability.

In embodiments, the molded article may have a yield stress measured in accordance with ASTM D638 of 15 MPa or more, 18 MPa or more, 20 MPa or more, 21 MPa or more, or 22 MPa or more, and the upper limit of the yield stress may be, for example, 50 MPa or less, 40 MPa or less, or 30 MPa or less.

In embodiments, the molded article may have a tensile modulus measured in accordance with ASTM D638 of 750 MPa or more, 780 MPa or more, 790 MPa or more, 800 MPa or more, 850 MPa or more, 900 MPa or more, 950 MPa or more, or 1000 MPa or more. The upper limit of the tensile modulus may be, for example, 1500 MPa or less or 1200 MPa or less.

In embodiments, the molded article may have an elongation measured in accordance with ASTM D638 of 125% or more, 130% or more, 135% or more, 140% or more, 150% or more, 160% or more, 170% or more, 180% or more, 190% or more, 200% or more, 250% or more, 300% or more, 350% or more, or 400% or more. The upper limit of the elongation may be, for example, 600% or less or 500% or less.

In embodiments, the molded article may have an impact strength measured in accordance with ASTM D256 of 50 kJ/m² or more, 55 kJ/m² or more, 60 kJ/m² or more, 65 kJ/m² or more, 70 kJ/m² or more, 75 kJ/m² or more, 80 kJ/m² or more, 85 kJ/m² or more, 90 kJ/m² or more, 95 kJ/m² or more, 100 kJ/m² or more, 105 kJ/m² or more, 110 kJ/m² or more, 115 kJ/m² or more, 120 kJ/m² or more, or 125 kJ/m² or more. The upper limit of the impact strength may be, for example, 200 kJ/m² or less or 150 kJ/m² or less.

In embodiments, the molded article may have a crystallinity measured by differential scanning calorimetry (DSC) of 48% or more, 50% or more, 52% or more, 54% or more, or 55% or more, and the upper limit of the crystallinity may be, for example, 70% or less or 60% or less. The crystallinity (Xc) may be calculated by Formula 1 below.

$$Xc ( \% ) = Δ {H}_{m} / ( Δ H {°}_{m} \times {w}_{PP} ) \times 100 \qquad [ Formula 1 ]$$

In Formula 1, ΔH°ₘ is the melting enthalpy of 100% crystalline polypropylene (209 J/g) and w_{PP} denotes the polypropylene content in the specimen. ΔHₘ denotes the melting enthalpy measured by differential scanning calorimetry. The melting enthalpy (ΔHₘ) may be measured from the melting peak during the second heating by, for example, heating the molded article from 30° C. to 200° C. at a heating rate of 10° C./min (first heating), cooling to 30° C. at a cooling rate of 10° C./min, and heating again to 200° C. at a heating rate of 10° C./min (second heating).

In embodiments, the molded article may have a crystallization temperature measured by differential scanning calorimetry (DSC) of 115° C. to 120° C. or 115° C. to 119.8° C.

Hereinafter, examples and experimental examples will be specifically illustrated and described below. However, the following examples and experimental examples are only illustrative, and the technology described in this specification is not limited thereto.

### Preparation Example 1: Synthesis of Propylene-Based Compatibilizer

### Synthesis of Isopropenyl-Terminated Polypropylene

40 g of homopolypropylene (H730F from SK geo centric; Mn: 48,200 g/mol, Mw: 574,000 g/mol, polydispersity index: 11.9, MI=3.5 g/10 min) was introduced into a round-bottom flask and heated at 380° C. for 4.5 hours under a vacuum of 400 mTorr. The residue in the flask was cooled to 200° C. and dissolved in 100 mL of xylene to obtain a xylene solution. The solution was precipitated into ethanol and collected, and the collected solid was dried in a vacuum oven at 60° C. for 12 hours to obtain isopropenyl-terminated polypropylene.

At this time, the formation of double bonds at both terminal ends was confirmed by 1H nuclear magnetic resonance (1H-NMR) analysis. Additionally, the synthesized isopropenyl-terminated polypropylene had a melting point (Tm) of 147° C. as measured by differential scanning calorimetry (DSC), a number-average molecular weight (Mn) of 4,520 g/mol as measured by 1H-NMR, and number-average molecular weight (Mn), weight-average molecular weight (Mw), and polydispersity index (Mw/Mn; PDI) values of 3,720 g/mol, 7,860 g/mol, and 2.11, respectively, as measured by high-temperature gel permeation chromatography (HT-GPC).

### Synthesis of Polypropylene Having Hydroxyl Groups at Both Terminal Ends

15 g of the isopropenyl-terminated polypropylene synthesized above, 75 mL of tetrahydrofuran (THF), 1.98 g of ammonium sulfate ((NH₄)₂SO₄), and 1.13 g of sodium borohydride (NaBH₄) were placed in a reactor, and the mixture was refluxed at 63° C. for 24 hours. Next, 75 mL of distilled water, 1.5 g of sodium hydroxide (NaOH), and 4.5 mL of hydrogen peroxide (H₂O₂) were added to the reactor, and the oxidation reaction was carried out at 60° C. for 24 hours. The reaction product was filtered, washed with hot water, ethanol, and acetone, and then dried in a vacuum oven at 60° C. for 12 hours to obtain polypropylene having hydroxyl groups at both terminal ends.

It was confirmed by ¹H-NMR analysis that the double bonds at both terminal ends were replaced with hydroxyl groups. Additionally, the number-average molecular weight (Mn), weight-average molecular weight (Mw), and polydispersity index (Mw/Mn; PDI) measured by high-temperature gel permeation chromatography (HT-GPC) were 3,210 g/mol, 6,760 g/mol, and 2.11, respectively.

### Preparation Example 2: Synthesis of Crosslinked Polyurethane

25 g of 1,6-hexanediol (HDO) and 55.5 g of methylene diphenyl diisocyanate (MDI) were mixed so that the molar ratio of HDO to MDI was 1:1.1. The mixture was dissolved in 100 mL of tetrahydrofuran (THF), and the reaction was carried out at 60° C. for 18 hours. Thereafter, the reaction product was cured in a vacuum oven at 90° C. for 24 hours, followed by vacuum drying to obtain completely cured polyurethane powder.

The glass transition temperature (Tg) measured by a dynamic mechanical analyzer (DMA) performed at a frequency of 1 Hz over a temperature range from 40° C. to 150° C. was 111° C. Additionally, the polyurethane powder was insoluble in tetrahydrofuran (THF), and no polymer peaks were observed in the 1H-NMR spectrum. These results confirmed that the final polyurethane was crosslinked.

### Preparation Example 3: Synthesis of Crosslinked Polyurethane

Commercial polyurethane paint (R-266 Bumper A/U clear, Noru Chemical) and a hardener were mixed in a 1:1 weight ratio and vigorously stirred to prepare a uniform mixture. The mixture was applied in a layer having a thickness of not greater than 1 cm on a Teflon plate and cured at room temperature for 24 hours in a hood. The sample after primary curing was further cured in an oven at 90° C. for at least 72 hours to form a fully crosslinked structure. The crosslinked polyurethane after curing was pulverized using a household mixer to obtain a powder.

The crosslinked polyurethane powder did not melt at 270° C., thereby confirming that the final polyurethane was crosslinked.

### Example 1

### Preparation of Polymer Blend

To prepare a blend of polypropylene and polyurethane, a twin-screw compounder was set at 200° C. and 120 rpm. 70 parts by weight of homopolypropylene (H730F from SK geo centric; Mn: 48,200 g/mol, Mw: 574,000 g/mol, polydispersity index: 11.9, melt index (MI)=3.5 g/10 min), 30 parts by weight of the crosslinked polyurethane of Preparation Example 2, 0.5 parts by weight of the polypropylene-based compatibilizer of Preparation Example 1, and 4 parts by weight of dibutyltin dilaurate (DBTDL) were added and melt-kneaded for 5 minutes. Thereafter, the polymer blend was obtained by extruding through the nozzle of the twin-screw compounder.

### Preparation of Polymer Blend Film

The polymer blend prepared above was annealed for 3 minutes in a hot press set at 200° C., then molded into a film by applying a pressure of 10 MPa for 3 minutes. The molded film was immediately immersed in water after removal from the hot press to achieve rapid cooling.

### Examples 2 and 3 and Comparative Examples 1 to 4

Polymer blends and polymer blend films were prepared in the same manner as Example 1, except that the amounts of the reactants were changed as shown in Table 1 below.

In Comparative Example 4, polypropylene-graft-maleic anhydride (PP-g-MAH) (Aldrich; MAH content 8-10 wt %, weight-average molecular weight (Mw) 9,100 g/mol) was used in place of the polypropylene-based compatibilizer of Preparation Example 1.

TABLE 1

| | | Crosslinked | | | |
|---|---|---|---|---|---|
| | | Polyurethane | | | |
| | | (Preparation | Propylene-based | PP-g- | DBTDL |
| | Homopolypropylene | Example 2) | Compatibilizer | MAH | Catalyst |
| Example 1 | 70 parts | 30 parts | 0.5 parts | — | 4 parts |
| | by weight | by weight | by weight | | by weight |
| Example 2 | 70 parts | 30 parts | 1 part | — | 4 parts |
| | by weight | by weight | by weight | | by weight |
| Example 3 | 70 parts | 30 parts | 2 parts | — | 4 parts |
| | by weight | by weight | by weight | | by weight |
| Comparative | 100 parts | — | — | — | — |
| Example 1 | by weight | | | | |
| Comparative | 70 parts | 30 parts | — | — | — |
| Example 2 | by weight | by weight | | | |
| Comparative | 70 parts | 30 parts | — | — | 4 parts |
| Example 3 | by weight | by weight | | | by weight |
| Comparative | 70 parts | 30 parts | — | 2 parts | 4 parts |
| Example 4 | by weight | by weight | | by weight | by weight |

### Example 4

A polymer blend and polymer blend film were prepared in the same manner as Example 1, except that the crosslinked polyurethane of Preparation Example 3 was used in place of the crosslinked polyurethane of Preparation Example 2 and 1 part by weight of the polypropylene-based compatibilizer of Preparation Example 1 was used.

### Examples 5 and 6 and Comparative Example 5

Polymer blends and polymer blend films were prepared in the same manner as Example 4, except that the amounts of the reactants were changed as shown in Table 2 below.

TABLE 2

| | | Crosslinked | | |
|---|---|---|---|---|
| | | Polyurethane | Propylene- | |
| | | (Preparation | based | DBTDL |
| | Homopolypropylene | Example 3) | Compatibilizer | Catalyst |
| Example 4 | 90 parts | 10 parts | 1 part | 4 parts |
| | by weight | by weight | by weight | by weight |
| Example 5 | 90 parts | 10 parts | 2 parts | 4 parts |
| | by weight | by weight | by weight | by weight |
| Example 6 | 90 parts | 10 parts | 5 parts | 4 parts |
| | by weight | by weight | by weight | by weight |
| Comparative | 90 parts | 10 parts | — | — |
| Example 5 | by weight | by weight | | |

### Experimental Example 1: Tensile Test

Tensile tests were conducted on the polymer films prepared in Examples 1 to 3 and Comparative Examples 1 to 4 as described below, and the results are shown in Table 3.

The tensile tests were conducted in accordance with ASTM D638 at 23±2° C. and 50±5% relative humidity using a universal testing machine (UTM) to measure yield stress, elongation, and tensile modulus. Specimens were prepared according to ASTM D638 Type V specifications, and average values were calculated by repeating measurements seven times at a tensile speed of 5 mm/min.

TABLE 3

| | Yield | Elongation | Tensile Modulus |
|---|---|---|---|
| | Stress | (%) | (MPa) |
| Example 1 | 16.1 ± 0.45 | 483.1 ± 36.2 | 943 ± 41 |
| Example 2 | 23.3 ± 1.5 | 347.7 ± 34.8 | 1106 ± 45 |
| Example 3 | 24.0 ± 1.5 | 228.6 ± 88.5 | 1129 ± 171.3 |
| Comparative | 25.8 | 805 | 1006 |
| Example 1 | | | |
| Comparative | 18.5 ± 1.3 | 4.4 ± 1.0 | 1209 ± 64 |
| Example 2 | | | |
| Comparative | 16.0 ± 1.0 | 222.9 ± 45.3 | 1091 ± 46 |
| Example 3 | | | |
| Comparative | 24.9 ± 0.6 | 9.5 ± 0.9 | 949 ± 34 |
| Example 4 | | | |

Referring to Table 3, Comparative Example 2, which is a simple blend of polypropylene and polyurethane, exhibited decreased yield stress and elongation compared to Comparative Example 1 containing only polypropylene. This result indicates that interfacial adhesion between two different polymers was reduced, resulting in deterioration of mechanical properties upon blending.

On the other hand, the polymer blend films of Examples 1 to 3, prepared using the polypropylene-based compatibilizer of Preparation Example 1 together with DBTDL, exhibited higher values for yield stress, elongation, and tensile modulus, indicating improved mechanical properties. Specifically, compared with Comparative Examples 2 to 4, the films of Examples 1 to 3 show improved values in one or more of yield stress, elongation, or tensile modulus.

Furthermore, comparing Example 3 with Comparative Example 4 at the same compatibilizer content, Example 3, which used the polypropylene-based compatibilizer together with DBTDL, showed higher elongation and tensile modulus than Comparative Example 4, which used the conventional compatibilizer PP-g-MAH.

These results indicate that the polymer blend according to one embodiment and the molded article including the polymer blend, when manufactured using a catalyst component and a polypropylene-based compatibilizer having hydroxyl groups at both terminal ends, may improve interfacial adhesion between polymers and may achieve higher yield stress, elongation, and tensile modulus.

### Experimental Example 2: Impact Test

Impact tests were conducted on the polymer films prepared in Examples 1 and 3 and Comparative Examples 1 to 3 in accordance with ASTM D256 (Notched Izod) at 23±2° C. and 50±5% relative humidity to measure impact strength. The results are shown in Table 4.

TABLE 4

| | Impact Strength (kJ/m²) |
|---|---|
| Example 1 | 125.9 |
| Example 3 | 108.4 |
| Comparative | 16.1 |
| Example 1 | |
| Comparative | 12.7 |
| Example 2 | |
| Comparative | 49.3 |
| Example 3 | |

Referring to Table 4, the polymer blend films of Examples 1 and 3 exhibited significantly higher impact strength compared to Comparative Examples 1 to 3.

These results indicate that, when the polymer blend according to one embodiment and a molded article including the polymer blend are manufactured using both a catalyst component and a polypropylene-based compatibilizer having hydroxyl groups at both terminal ends, interfacial adhesion between polymers may be improved, providing higher impact strength.

### Experimental Example 3: Morphology Analysis

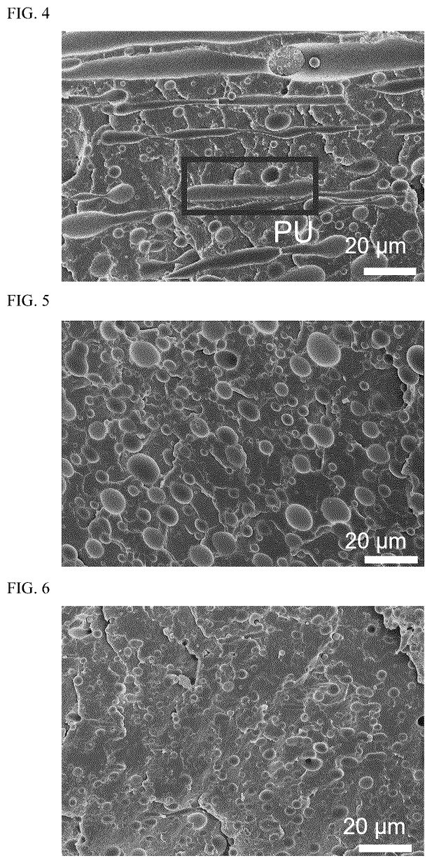

The phase separation morphology of polymer blends was observed using scanning electron microscopy (SEM) for the polymer films prepared in Examples 1 to 3 and Comparative Examples 2 and 3. Specimens were prepared by cryo-fracture in liquid nitrogen followed by platinum (Pt) plating, and were photographed at an acceleration voltage of 10 kV, with the results shown in FIGS. 3 to 9.

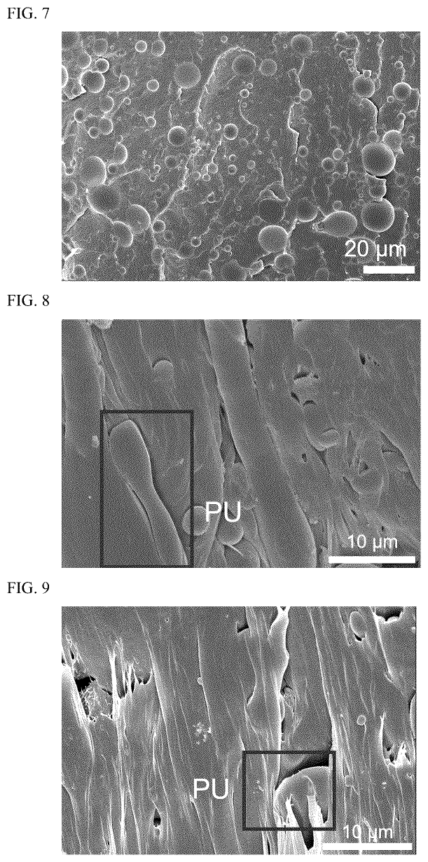

FIG. 3 is a scanning electron microscopy (SEM) cross-sectional image of Comparative Example 2, FIG. 4 is an SEM cross-sectional image of Comparative Example 3, FIG. 5 is an SEM cross-sectional image of Example 1, FIG. 6 is an SEM cross-sectional image of Example 2, and FIG. 7 is an SEM cross-sectional image of Example 3. FIG. 8 is an SEM cross-sectional image taken after tensile testing of the polymer blend film of Example 2, and FIG. 9 is an SEM cross-sectional image taken after tensile testing of the polymer blend film of Example 3.

Referring to FIG. 3, Comparative Example 2, which is a simple blend of polypropylene and polyurethane, was observed to have phases that were not uniformly dispersed. Referring to FIG. 4, Comparative Example 3, which is a polymer blend containing DBTDL only, showed that the polyurethane dispersed phase was not uniformly distributed and was formed as a mixture of relatively large and small dispersed-phase domains. The average size of the dispersed phase in Comparative Example 3 was measured to be 9.43±9.13 μm.

By contrast, referring to FIGS. 5 to 7, the polymer blend films of Examples 1 to 3, prepared using both the polypropylene-based compatibilizer of Preparation Example 1 and DBTDL, exhibited polyurethane dispersed phases that were uniformly distributed and relatively small in size. Specifically, the average sizes of the dispersed phases in Examples 1 to 3 were measured to be 7.10±3.59 μm, 3.80±1.64 μm, and 6.64±3.76 μm, respectively.

Referring to FIGS. 8 and 9, in the polymer blend films of Examples 2 and 3, the polyurethane dispersed phase was observed to elongate together with the polypropylene continuous phase after the tensile test.

These observations indicate that, when the polymer blend according to one embodiment and a molded article including the polymer blend are manufactured using both a catalyst component and a polypropylene-based compatibilizer having hydroxyl groups at both terminal ends, interfacial adhesion between polymers may be improved, and a uniformly distributed dispersed phase may be achieved.

### Experimental Example 4: Rheological Analysis

Frequency sweeps were performed on the polymer films prepared in Examples 1 to 3 and Comparative Examples 2 and 3 using a rheometer at 190° C. over a frequency range of 0.01 to 100 rad/s. Storage modulus (G′), loss modulus (G″), loss tangent (tan 8), and complex viscosity were measured, and viscoelastic behavior and shear-thinning behavior were evaluated from the results.

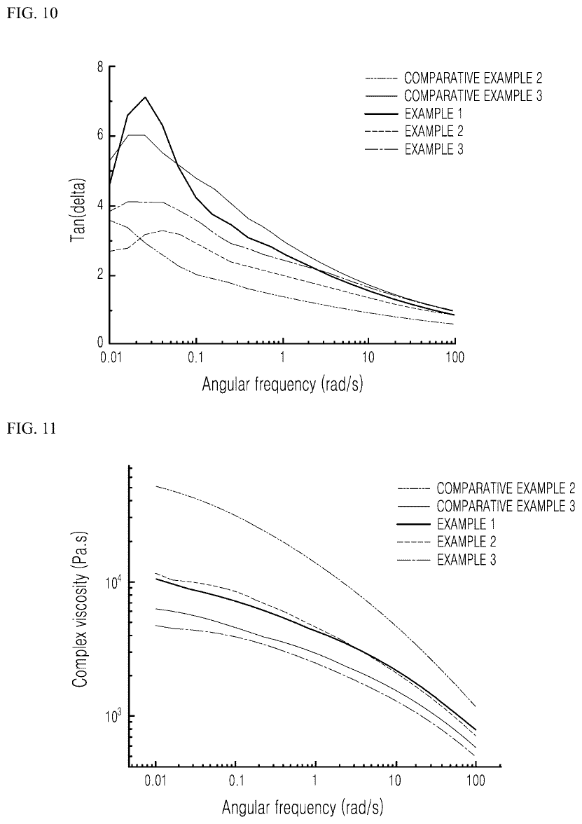

FIG. 10 is a loss tangent graph versus frequency, and FIG. 11 is a complex viscosity graph versus frequency. Referring to these figures, the complex viscosity in Examples 1 to 3 was observed to remain stable, thereby maintaining the fluidity of the blend. In addition, distinct compatibilization effects appeared in the loss-tangent characteristics under both conditions, indicating that the interfacial structure and viscoelastic properties can be controlled according to variations in compatibilizer content.

Next, temperature sweeps were performed from 30° C. to 150° C. using a dynamic mechanical analyzer (DMA) on the polymer films prepared in Examples 1 to 3 and Comparative Examples 2 and 3. The storage modulus and loss tangent (tan 8) were measured under conditions of 0.01% strain amplitude and 1 Hz frequency, and the temperature dependence of the loss tangent was evaluated.

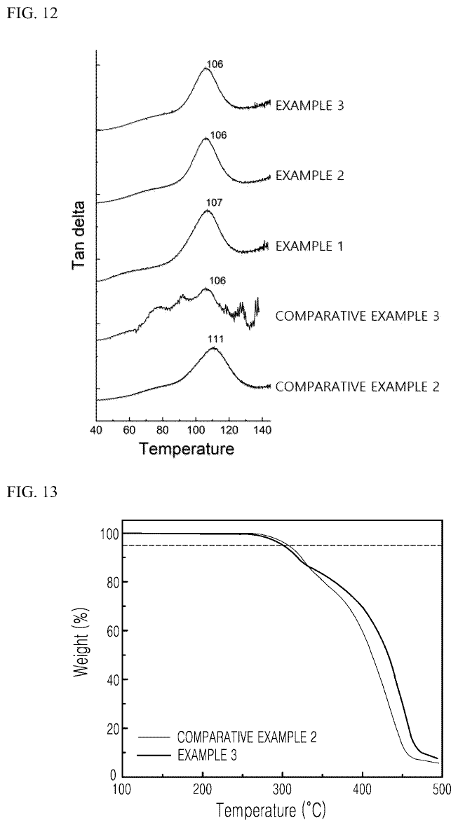

FIG. 12 is a loss tangent graph versus temperature. Referring to FIG. 12, for Comparative Example 3, which is a polymer blend containing only DBTDL, the tan & curve appeared broad and non-uniformly split. This may indicate that polyurethane decomposed or that the reaction proceeded non-uniformly.

By contrast, for Examples 1 to 3, where the polypropylene-based compatibilizer was added together with DBTDL, the tan 8 peaks were observed to be sharp. This indicates that the polypropylene-based compatibilizer suppresses random decomposition of polyurethane and promotes the formation of dispersed phases of relatively uniform size, and may further indicate that covalent bonds were formed between the polypropylene-based compatibilizer and polyurethane.

### Experimental Example 5: Thermal Analysis

Thermogravimetric changes were measured for the polymer films prepared in Example 3 and Comparative Example 2 using a thermogravimetric analyzer (TGA) under nitrogen from 30° C. to 500° C. at a heating rate of 10° C./min.

FIG. 13 is a graph showing thermogravimetric analysis curves versus temperature. Referring to FIG. 13, the 5 wt % decomposition temperatures of Example 3 and Comparative Example 2 were not significantly different, indicating similar initial thermal stability. However, in Example 3, delayed decomposition behavior was observed from around 330° C., which suggests that the addition of the polypropylene-based compatibilizer and DBTDL catalyst may confer a flame-retardant effect.

Next, thermal properties were analyzed for the polymer films prepared in Examples 1 to 3 and Comparative Examples 1 to 4 using differential scanning calorimetry (DSC) under a nitrogen atmosphere at a heating or cooling rate of 10° C./min. The temperature program proceeded in the order of first heating (30° C.→200° C.), cooling (200° C.→30° C.), and second heating (30° C.→200° C.), and the data from the second heating were used for analysis. The melting point (Tm), crystallization temperature (Tc), and melting enthalpy (ΔHₘ) were measured, and the crystallinity (Xc) was calculated by Formula 1 below. The results are shown in Table 5.

$$Xc ( \% ) = Δ {H}_{m} / ( Δ H {°}_{m} \times {w}_{PP} ) \times 100 \qquad [ Formula 1 ]$$

In Formula 1, ΔH°ₘ is the melting enthalpy of 100% crystalline polypropylene (209 J/g) and w_{PP} denotes the polypropylene content in the specimen.

TABLE 5

| | Tm (° C.) | Tc (° C.) | Xc (%) |
|---|---|---|---|
| Example 1 | 159.3 | 116.8 | 53.5 |
| Example 2 | 160.3 | 118 | 55.7 |
| Example 3 | 160.7 | 119.7 | 50.7 |
| Comparative | 162.3 | 120.0 | 50.2 |
| Example 1 | | | |
| Comparative | 162.3 | 123.4 | 61.4 |
| Example 2 | | | |
| Comparative | 161.1 | 119.4 | 49.2 |
| Example 3 | | | |
| Comparative | 162.4 | 124.5 | 46.9 |
| Example 4 | | | |

Referring to Table 5, Comparative Example 4, which used the conventional compatibilizer polypropylene-graft-maleic anhydride (PP-g-MAH), showed significantly reduced crystallinity. By contrast, Examples 1 to 3 showed high crystallinity values of 50% or higher, with uniformly distributed polyurethane dispersed phases. These results suggest that, whereas PP-g-MAH may interfere with crystal formation and reduce crystallinity, using the polypropylene-based compatibilizer having hydroxyl groups at both terminal ends together with the catalyst component may allow crystallization to proceed smoothly, producing a more stable crystalline structure.

### Experimental Example 6: Application to Commercial Paint

To evaluate whether the composition for a polymer blend of the present disclosure is applicable to actual automotive paint systems, polymer blend films were prepared using commercial paints, as in Examples 4 to 6.

Tensile tests were conducted on the polymer films prepared in Examples 4 to 6, Comparative Example 1, and Comparative Example 5 in the same manner as Experimental Example 1, and the results are shown in Table 6.

TABLE 6

| | Yield | | Tensile Modulus |
|---|---|---|---|
| | Stress | Elongation (%) | (MPa) |
| Example 4 | 22.4 ± 0.7 | 246 ± 117 | 931 ± 64 |
| Example 5 | 21.7 ± 0.8 | 178 ± 127 | 859 ± 66 |
| Example 6 | 23.1 ± 0.8 | 143 ± 108 | 923 ± 54 |
| Comparative | 25.8 | 805 | 1006 |
| Example 1 | | | |
| Comparative | 21.3 ± 1.2 | 41.4 ± 8.3 | 923 ± 35 |
| Example 5 | | | |

Referring to Table 6, the polymer blend films of Examples 4 to 6, prepared using the polypropylene-based compatibilizer of Preparation Example 1 together with DBTDL, showed high values for yield stress, elongation, and tensile modulus, confirming improved mechanical properties. Specifically, the films of Examples 4 to 6 exhibited significantly higher elongation than Comparative Example 5, which is a simple blend of polypropylene and polyurethane.

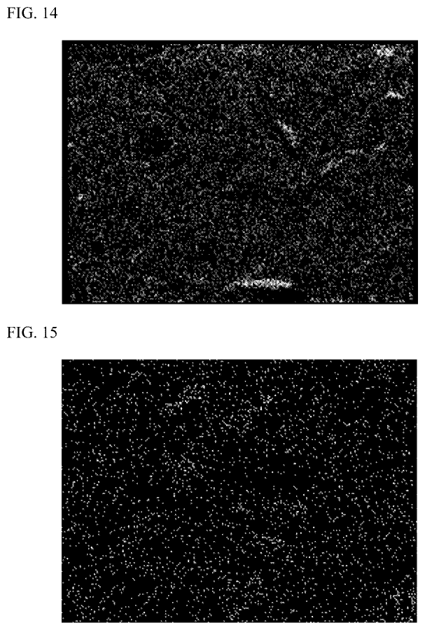

FIG. 14 is an oxygen elemental mapping image obtained by scanning electron microscopy-energy dispersive X-ray spectroscopy (SEM-EDS) of the polymer film manufactured in Comparative Example 5, and FIG. 15 is an oxygen elemental mapping image obtained by SEM-EDS of the polymer film manufactured in Example 4.

Referring to FIGS. 14 and 15, Comparative Example 5 showed a non-uniform oxygen elemental distribution, indicating that the dispersed phase was not uniformly distributed. By contrast, in Example 4, oxygen was observed to be uniformly distributed throughout the film, confirming that the polyurethane dispersed phase was more uniformly distributed in the polypropylene continuous phase. These results suggest that the polypropylene-based compatibilizer and catalyst component according to one embodiment are applicable to actual paint systems.

Although the scope of the present disclosure has been described by specific matters and limited embodiments in the present specification, the embodiments are provided only for assisting the understanding of the present disclosure more generally, and the present disclosure is not limited to the embodiments disclosed herein. Various modifications and changes may be made to the embodiments by those skilled in the art to which the present disclosure pertains from the description and shall be understood as being included in the embodiments disclosed herein.

1. A composition for a polymer blend, comprising:
a polymer component comprising a first polymer and a second polymer different from the first polymer;
a polypropylene-based compatibilizer having two terminal ends and hydroxyl groups (—OH) at both terminal ends; and
a catalyst component comprising one or more of a tin-based catalyst, a zirconium-based catalyst, or combinations thereof.

2. The composition for a polymer blend of claim 1, wherein the polypropylene-based compatibilizer is included in an amount of 0.01 to 10 parts by weight based on 100 parts by weight of the polymer component.

3. The composition for a polymer blend of claim 1, wherein the polypropylene-based compatibilizer has a number-average molecular weight (Mn) of 1,000 g/mol to 30,000 g/mol.

4. The composition for a polymer blend of claim 1, wherein the catalyst component is included in an amount of 0.01 to 10 parts by weight based on 100 parts by weight of the polymer component.

5. The composition for a polymer blend of claim 1, wherein the catalyst component comprises one or more of dibutyltin dilaurate (DBTDL), tin(II) 2-ethylhexanoate (Sn(Oct)₂), zirconium acetylacetonate, or zirconium tetrakis(2,2,6,6-tetramethyl-3,5-heptanedionate).

6. The composition for a polymer blend of claim 1, wherein the second polymer is crosslinked.

7. The composition for a polymer blend of claim 1, wherein the first polymer does not comprise polar functional groups, and the second polymer comprises polar functional groups.

8. The composition for a polymer blend of claim 1, wherein the first polymer comprises a polyolefin-based polymer, and the second polymer comprises a polyurethane-based polymer.

9. The composition for a polymer blend of claim 1, wherein the first polymer comprises a polypropylene-based polymer, and the second polymer comprises a crosslinked polyurethane-based polymer.

10. The composition for a polymer blend of claim 1, wherein the polymer component comprises 30 wt % to 95 wt % of the first polymer and 5 wt % to 70 wt % of the second polymer.

11. A polymer blend, comprising:
a polymer component comprising a first polymer and a second polymer that is different from the first polymer;
a polypropylene-based compatibilizer residue covalently bonded to the second polymer; and
a catalyst component comprising one or more of a tin-based catalyst, a zirconium-based catalyst, or combinations thereof.

12. The polymer blend of claim 11, wherein the compatibilizer residue is derived from a polypropylene-based compatibilizer having two terminal ends and hydroxyl groups (—OH) at both terminal ends.

13. The polymer blend of claim 11, wherein the polymer component comprises a continuous phase comprising the first polymer and a dispersed phase comprising the second polymer.

14. The polymer blend of claim 11, wherein the compatibilizer residue is bonded to the second polymer via urethane bonds.

15. The polymer blend of claim 11, wherein the catalyst component comprises one or more of dibutyltin dilaurate (DBTDL), tin(II) 2-ethylhexanoate (Sn(Oct)₂), zirconium acetylacetonate, or zirconium tetrakis(2,2,6,6-tetramethyl-3,5-heptanedionate).

16. A molded article comprising the polymer blend of claim 11.

17. The molded article of claim 16, having a yield stress of 15 MPa or greater as measured in accordance with ASTM D638.

18. The molded article of claim 16, having a tensile modulus of 750 MPa or greater as measured in accordance with ASTM D638.

19. The molded article of claim 16, having an impact strength of 50 kJ/m² or greater as measured in accordance with ASTM D256.

20. The molded article of claim 16, having a crystallinity of 48% or greater as measured by differential scanning calorimetry.
